(19) United States
(12) Patent Application Publication
(10) Pub. No.: US 2012/0008042 A1
(43) Pub. Date: Jan. 12, 2012

(54) SUPPORT STRUCTURE AND DOCUMENT PROJECTOR USING THE SAME

(75) Inventors: Yo-Jung WANG, TAIPEI HSIEN (TW); Ming-Hung HSIA, TAIPEI HSIEN (TW); Chen-Cheng LEE, TAIPEI HSIEN (TW)

(73) Assignee: AVERMEDIA INFORMATION, INC., TAIPEI HSIEN (TW)

(21) Appl. No.: 12/832,072

(22) Filed: Jul. 8, 2010

(51) Int. Cl. H04N 5/225; F16L 11/118

(52) U.S. Cl. 348/373; 285/153.2; 348/E05.025

(57) ABSTRACT

A support structure is disclosed, which includes plural cylindrical joints. Each cylindrical joint includes a cylindrical joint body having a wire channel for being passed through by a wire, a cylindrical joint head disposed on one end of the cylindrical joint body and having the wire channel, a cylindrical joint socket disposed on another end of the cylindrical joint body and having the wire channel The cylindrical joints are connected one by one by coupling the cylindrical joint to the corresponding cylindrical joint socket and are rotated along the radial direction of the cylindrical joint head.

### BACKGROUND

1. Field of Invention

The present invention relates to a support structure. More particularly, the present invention relates to a support structure using cylindrical joints.

2. Description of Related Art

A document projector instantly projects the image of an object onto a screen and does not need to make an image or a document file. The object placed on the shooting zone of a projector camera may be captured and projected on the screen instantly in the document projector. Thus, the document projector is a convenient aid for showing the current status of the object instantaneously.

The degree of freedom for operating the document projector is provided by a rotating shaft or a hinge in a conventional document projector. However, there may be more than one rotating shaft or hinge arranged in the conventional document projector to provide multiple degrees of freedom, and that would take a lot of space in the document projector and be expensive. Some of the document projectors may use gooseneck support structure. However, the material of the gooseneck support structure is metal, which would increase the weight of the product. Even though the degree of freedom of the metal gooseneck support structure is higher than the mechanism support structure with the hinge or rotating shaft, the metal gooseneck support structure made by twisting metal chains can not provide rotational degree of freedom. The metal gooseneck support structure may lack of steady support due to metal fatigue after a period of time.

### SUMMARY

An aspect of the invention provides a support structure which includes plural cylindrical joints. Each cylindrical joint includes a cylindrical joint body having a wire channel for being passed through by a wire, a cylindrical joint head disposed on one end of the cylindrical joint body and having the wire channel, a cylindrical joint socket disposed on another end of the cylindrical joint body and having the wire channel, plural grooves disposed on the cylindrical joint head are arranged on opposite sides of the wire channel along a radial direction of the cylindrical joint head, and plural pins disposed on the cylindrical joint socket and arranged at opposites sides of the wire channel and touching the grooves. The cylindrical joints are connected one by one by coupling the cylindrical joint to the corresponding cylindrical joint socket and are rotated along the grooves and stopped by the pins. The material of the cylindrical joints is plastic.

Another aspect of the invention provides a document projector using the support structure.

Another aspect of the invention provides a support structure, which includes at least one cylindrical joint, at least one ball joint, and an adapter joint for connecting the cylindrical joint and the ball joint. Each cylindrical joint includes a cylindrical joint body having a wire channel for being passed through by a wire, a first cylindrical joint head disposed on one end of the cylindrical joint body and having the wire channel, a first cylindrical joint socket disposed on another end of the cylindrical joint body and having the wire channel, plural first grooves disposed on the first cylindrical joint head and arranged on opposite sides of the wire channel along a radial direction of the cylindrical joint head, and plural first pins disposed on the first cylindrical joint socket and arranged at opposites sides of the wire channel and touching the grooves. Each ball joint includes a ball joint body having the wire channel, a second ball joint head disposed on an end of the ball joint body and having the wire channel, a second ball joint socket disposed on another end of the ball joint body and having the wire channel, a second cavity disposed on an inner surface of the second ball joint socket; and a second protrusion disposed on an outer surface of the second ball joint head. The adapter joint includes an adapter joint body having the wire channel, a third cylindrical joint socket disposed on an end of the adapter joint body and having the wire channel and coupled to the first cylindrical joint head of the least one cylindrical joint, a third ball joint head disposed on another end of the adapter joint body and having the wire channel and coupled to the second ball joint socket of the least one ball joint, plural third pins disposed on the third cylindrical joint socket and touching the first grooves for positioning, and a third protrusion disposed on an outer surface of the third ball joint head and coupling to the second cavity for positioning. The material of the cylindrical joint, the ball joint, and the adapter joint is plastic. The protrusion has an arch edge. The number of the least one cylindrical joint and the least one ball joint can be plural, and the cylindrical joints are coupled one by one with coupling the first cylindrical joint heads to the first cylindrical joint sockets, and the ball joints are coupled one by one by coupling the second ball joint heads to the second ball joint sockets. The support structure further includes a base and a lower joint, wherein the lower joint connects the cylindrical joints and the base. The support structure further includes an electronic device and an upper joint, wherein the upper joint connects the ball joints and the electronic device.

The support structure use the cylindrical joints, wherein the contact area between the cylindrical joint is larger than the contact area between the ball joints, therefore the friction force between the cylindrical joint head and the cylindrical joint socket is increased. The cylindrical joints may increase the rigidity of the support structure and prevents sway of the support structure. The support structure may include the ball joints and the cylindrical joints, wherein the cylindrical joints can provide the support structure better rigidity, and the ball joints can provide the support structure better degree of freedom during positioning.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A and FIG. 1B are schematic diagrams of different states of a first embodiment of the support structure of the invention;

FIG. 2A and FIG. 2B are oblique diagrams of the cylindrical joint 110 in FIG. 1B in different views;

FIG. 3 is a schematic diagram of a document projector using the support structure 100 in FIG. 1A;

FIG. 4 is a schematic diagram of a second embodiment of the support structure of the invention; and

FIG. 5 is a schematic diagram of a document projector using the support structure 300 of FIG. 4.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

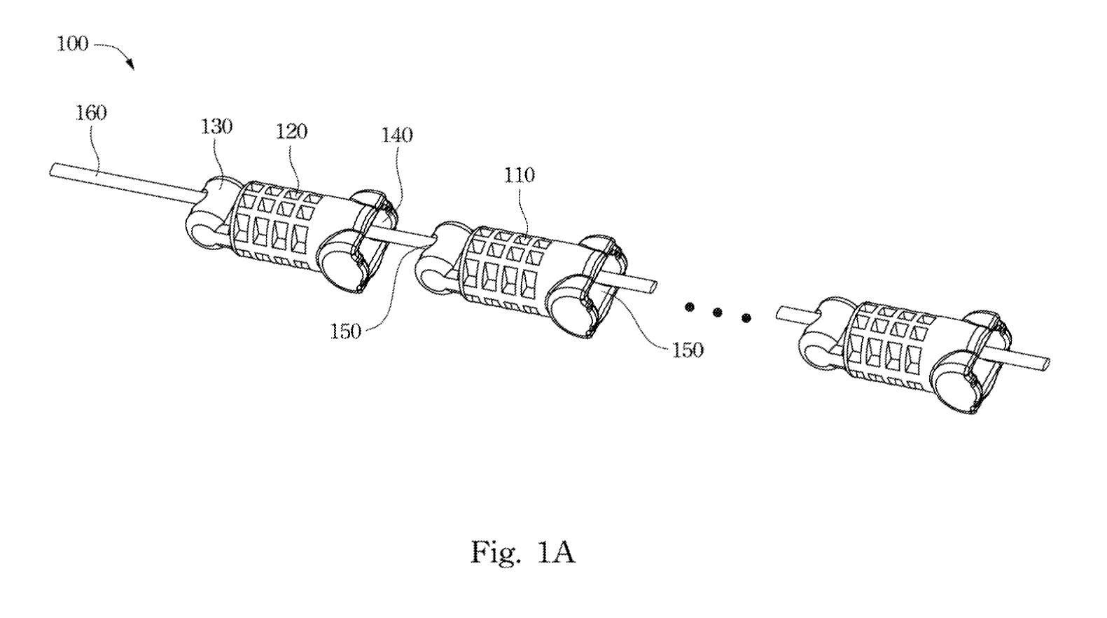

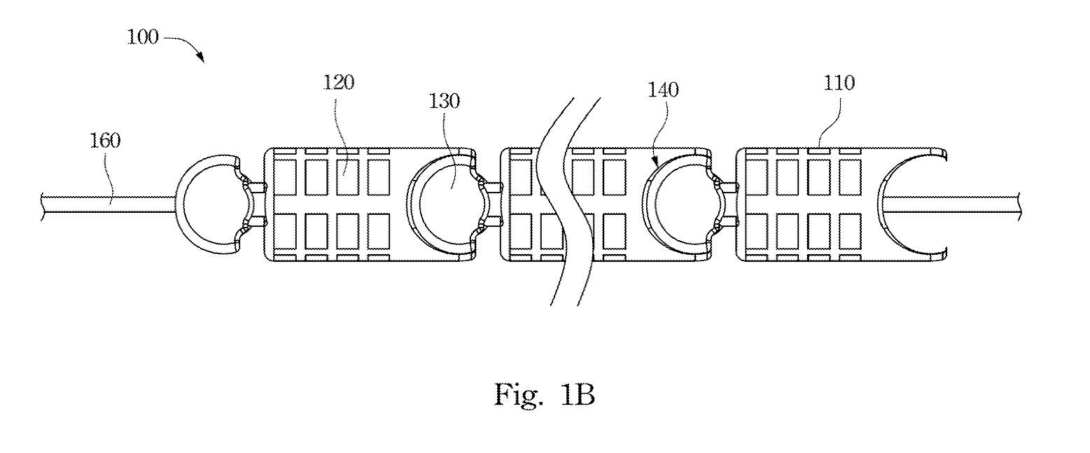

Refer to FIG. 1A and FIG. 1B. FIG. 1A and FIG. 1B are schematic diagrams of different states of a first embodiment of the support structure of the invention. The support structure 100 includes plural cylindrical joints 110, and the cylindrical joints 110 are coupled one by one to form the support structure 100. Each cylindrical joint 110 includes a cylindrical joint body 120, a cylindrical joint head 130 disposed on an end of the cylindrical joint body 120, and a cylindrical joint socket 140 disposed on another end of the cylindrical joint body 120. The cylindrical joints 120 are coupled one by one by coupling the cylindrical joint heads 130 to the cylindrical joint sockets 140 respectively. The two neighbor cylindrical joints 110 can be rotated along a radial direction of the cylindrical joint head 130 and the cylindrical joint socket 140.

The support structure 100 is a hollow structure. A wire 160 can pass through the support structure 100. More particularly, the cylindrical joint body 120, the cylindrical joint head 130 and the cylindrical joint socket 140 have a wire channel 150, therefore the support structure 100 formed by coupling the cylindrical joints 110 would have the wire channel 150 for being passed through by the wire 160.

The material of the support structure 100 can be plastic. The weight of the support structure 100 using the plastic material is lighter than the weight of using metal material, thus the total weight of the product can be reduced and prevent metal fatigue. The cylindrical joints 110 are designed to be rotated along the radial direction of the cylindrical joint heads 130 and the cylindrical joint sockets 140. Though the rotational degree of freedom is limited, the is rigidity of the support structure 100 can be highly increased and prevent the sway of the support structure 100.

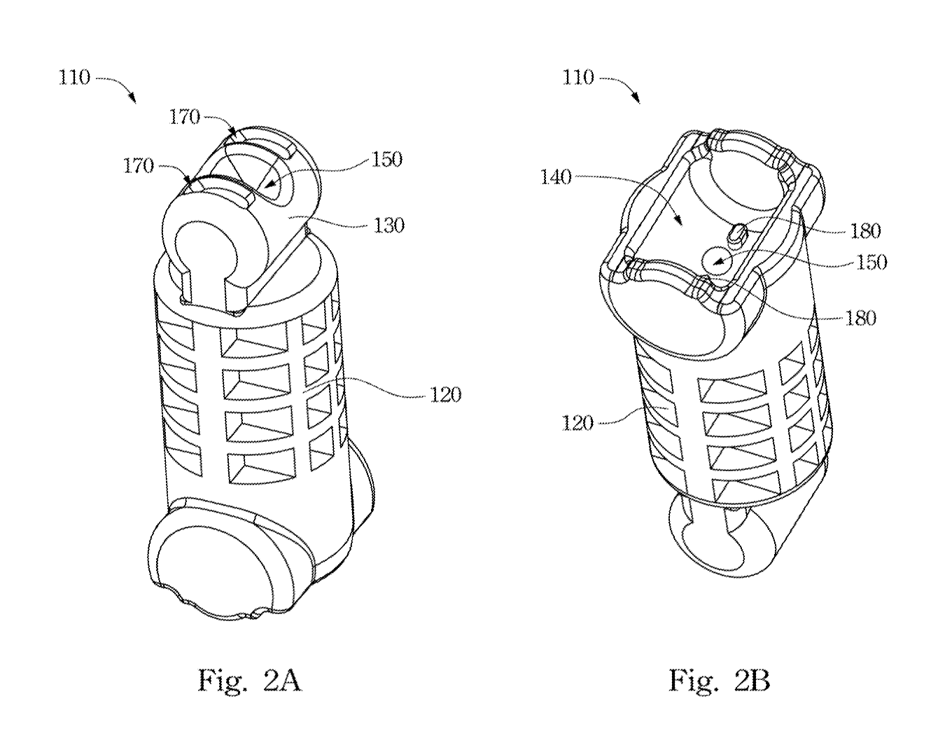

Refer to FIG. 2A and FIG. 2B. FIG. 2A and FIG. 2B are oblique diagrams of the cylindrical joint 110 in FIG. 1B in different views. The cylindrical joint 110 includes the cylindrical joint body 120, and the cylindrical joint head 130 and the cylindrical joint socket 140 disposed on opposite ends of the cylindrical joint body 110. The cylindrical joint body 110, the cylindrical joint head 130, and the cylindrical joint socket 140 have the wire channel 150. The sectional shape of the cylindrical joint head 130 is a circle or an ellipse. The sectional shape of the cylindrical joint socket 140 is a circle or an ellipse. The wire channel 150 is perpendicular to the axial direction of the cylindrical joint head 130 and the cylindrical joint socket 140. The cylindrical joint head 130 is coupled to the cylindrical joint socket 140 for connecting the cylindrical joints 110. The cylindrical joints 110 would be rotated along the radial direction of the cylindrical joint head 130 and the cylindrical joint socket 140.

The cylindrical joint 110 further includes plural grooves 170 disposed on the cylindrical joint head 130, and plural pins 180 disposed on the cylindrical joint socket 140. The grooves 170 are arranged along the radial direction of the cylindrical joint head 130 and arranged at opposite sides of the wire channel 150. The pins 180 are disposed on opposite sides of the wire channel 150 and corresponding to the grooves 170.

The width of the cylindrical joint socket 140 is slightly smaller than the width of the cylindrical joint head 130, therefore the cylindrical joint head 130 would not be easily pulled out from the cylindrical joint socket 140 when the cylindrical joint head 130 is inserted into the cylindrical joint socket 140. The inner radius of the cylindrical joint socket 140 is approximately the same as the outer radius of the cylindrical joint head 130. The cylindrical joints 110 are positioned by the friction force between the cylindrical joint head 130 and the cylindrical joint socket 140.

The pins 180 would touch the corresponding grooves 170 when the two cylindrical joints 110 couple to each other. The cylindrical joints 110 are rotated along the path of the grooves 170 and stopped when the pins 180 touch the ends of the grooves 170. Thus the cylindrical joints 110 are rotated along the radial direction of the cylindrical joint head 130 and the cylindrical joint socket 140. The rotary angle of the cylindrical joints 110 are decided by the length of the grooves 170.

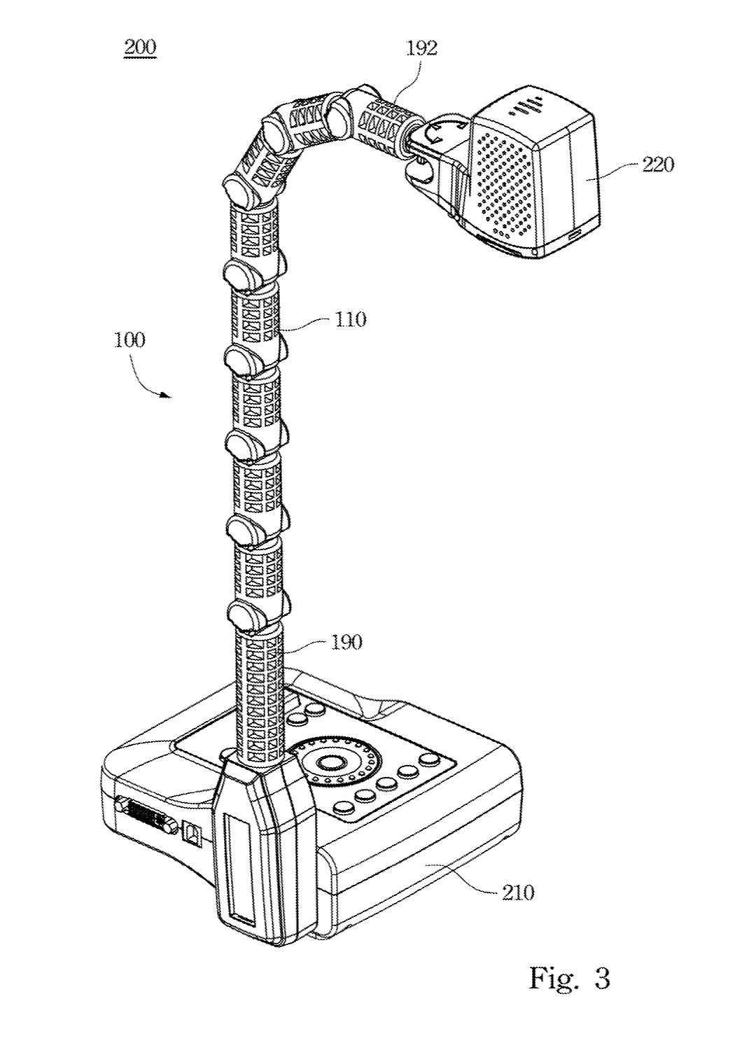

Refer to FIG. 3. FIG. 3 is a schematic diagram of a document projector using the support structure 100 in FIG. 1A. The document projector 200 includes a base 210, an image capturing device 220, and the support structure for connecting the base 210 to the image capturing device 220. The support structure 100 is formed by coupling plural cylindrical joints 110. The support structure 100 further includes a lower joint 190 to connect the base 210 and one of the cylindrical joints 110. The support structure 100 further includes an upper joint 192 to connect the image capturing device 220 and one of the cylindrical joint 110. The cylindrical joints 110 of the support structure 100 can be rotated along the predetermined direction to change the position of the image capturing device 220.

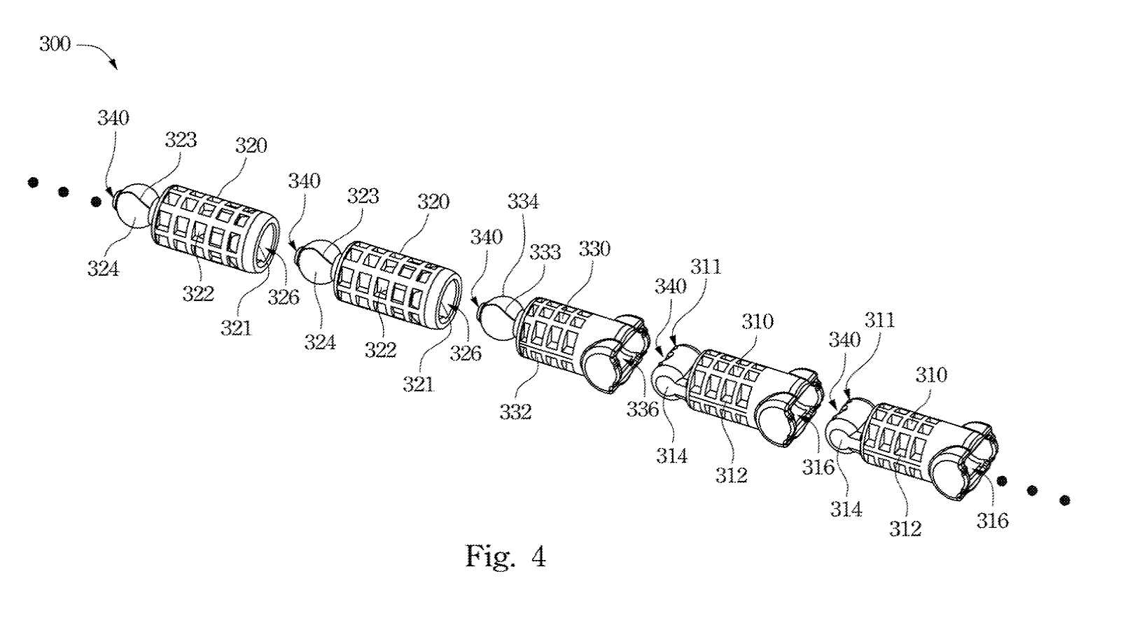

Refer to FIG. 4. FIG. 4 is a schematic diagram of a second embodiment of the support structure of the invention. The support structure 300 can be fastened on a base to support electronic device. The support structure 300 includes at least one cylindrical joint 310, at least one ball joint 320, and an adapter joint 330 to connect the least one cylindrical joint 310 and the least one ball joint 320.

The cylindrical joint 310 includes a cylindrical joint body 312, a first cylindrical joint head 314 disposed on an end of the cylindrical joint body 312, and a first cylindrical joint socket 316 disposed on another end of the cylindrical joint body 312. The cylindrical joint body 312, the first cylindrical joint head 314 and the cylindrical joint socket 316 have the wire channel 340. The width of the opening of the cylindrical joint socket 316 is slightly smaller than the width of the first cylindrical joint head 314 to prevent the first cylindrical joint head 314 departing from the first cylindrical joint socket 316 when two cylindrical joints 310 are coupled.

The cylindrical joint 310 further includes plural grooves 311 disposed on the first cylindrical joint head 314. The first grooves 311 are disposed on opposite sides of the wire channel 340. The cylindrical joint 310 further includes plural first pins (see FIG. 2B) disposed inside of the first cylindrical joint socket 316 and disposed on opposite sides of the wire channel 340. The first pins disposed on the first cylindrical joint socket 316 would touch the first grooves 311 disposed on the first cylindrical joint head 314 for positioning when two cylindrical joints 310 are coupled, and the rotary angle of the cylindrical joints 310 is limited by the first grooves 311.

The ball joint 320 includes a ball joint body 322, a second ball joint head 324 disposed on an end of the ball joint body 322, and a second ball joint socket 326 disposed on another end of the ball joint body 322. The width of the second ball joint socket 326 is slightly smaller than the width of the second ball joint head 324 to prevent the second ball joint head 324 departing from the second ball joint socket 326 when two ball joints 320 are coupled. The ball joints 320 can be positioned by the friction force between the second ball joint heads 324 and the second ball joint sockets 326. The ball joint body 322, the second ball joint head 324, and the second ball joint socket 326 have the wire channel 340.

In order to prevent the wire in the wire channel 340 from being damaged due to over rotary, the ball joint 320 further includes a second cavity 321 disposed on the inner surface of the second ball joint socket 326, and a second protrusion 323 disposed on the outer surface of the ball joint head 324. The second protrusion 323 is located in the second cavity 321 when coupling two ball joints 320. The rotary angle of the ball joint 320 is limited when the second protrusion 323 touches the edge of the second cavity 321, therefore the ball joint 320 would not be over rotated at the Z direction, which is parallel to the wire channel 340.

In order to rotate the ball joints 320 smoothly, the second protrusion 323 can have an arch edge; therefore the second ball joint head 324 can move smoothly in the second ball joint socket 326 when the ball joint 320 is rotated. Unlike the rotary angle of the ball joints at the Z direction is limited by the second protrusion 323 touching the second cavity 321, the rotary angle of the ball joints 320 at the X an Y direction is not limited.

The adapter joint 330 is used to connect the cylindrical joint 310 and the ball joint 320. The adapter joint 330 includes a adapter joint body 332, a third ball joint head 334 disposed on an end of the adapter joint body 332, and a third cylindrical joint socket 336 disposed on another end of the adapter joint body 332. The adapter joint body 332, the third ball joint head 334, and the third cylindrical joint socket 336 have the wire channel 340. The third cylindrical joint socket 336 is coupled to the first cylindrical joint head 314 to connect the adapter joint 330 and the cylindrical joint 310. The third ball joint head 334 is coupled to the second ball joint socket 326 to connect the adapter joint and the ball joint 320.

The adapter joint 330 further includes plural third pins (see FIG. 2B) disposed on the third cylindrical joint socket 336. The third pins would touch the first grooves 311 when the adapter joint 330 couples to the corresponding cylindrical joint 310 to restrict the rotary angle between the adapter joint 330 and the cylindrical joint 310. The adapter joint 330 further includes a third protrusion 333 disposed on the third ball joint head 334. The third protrusion 333 would touch the second cavity 321 when the adapter joint 330 couples to the corresponding ball joint 320 to restrict the rotary angle between the adapter joint 330 and the ball joint 320.

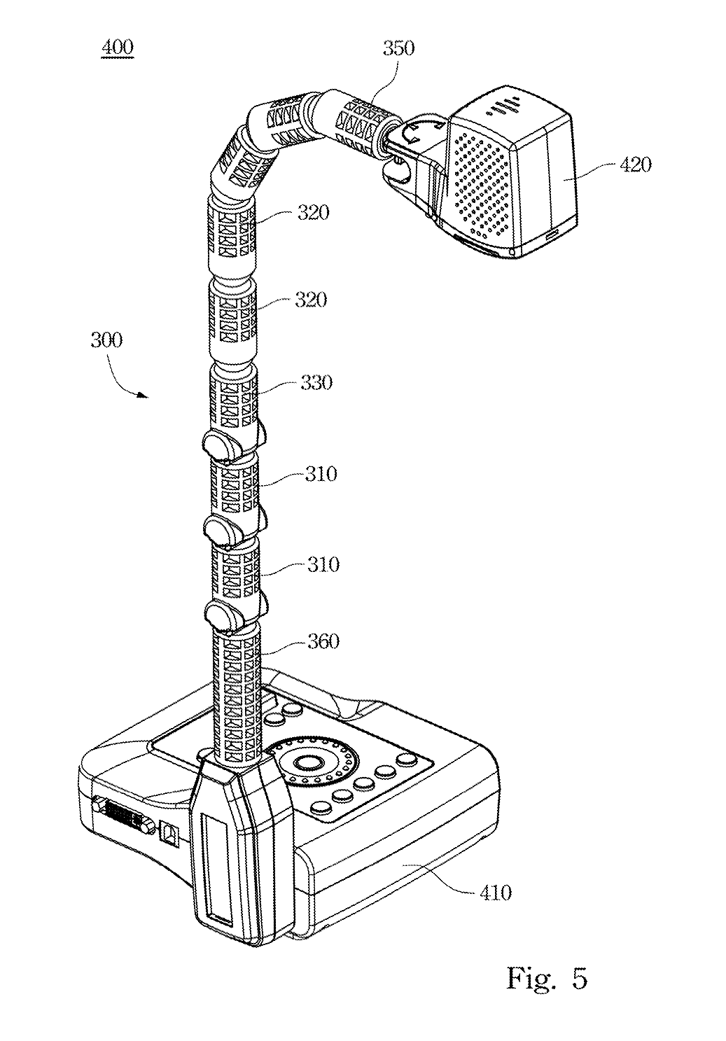

Refer to FIG. 5. FIG. 5 is a schematic diagram of a document projector using the support structure 300 of FIG. 4. The document projector 400 includes a base 410, the support structure 300, and an image capturing device 420. The support structure 300 includes plural cylindrical joints 310, plural ball joints 320, and an adapter joint 330 for connecting the cylindrical joints 310 and the ball joins 320. The support structure 300 further includes an upper joint 350 and a lower joint 360. The lower joint 360 connects the base 410 and one of the cylindrical joints 310. The upper joint 350 connects the image capturing device 420 and one of the ball joints 320.

The cylindrical joints 310 of the support structure 300 are arranged close to the base 410. The contact area between the cylindrical joints 310 is larger than the contact area between the ball joints 320; therefore the friction force between the cylindrical joints 310 is larger than the friction force between the ball joints 320. The cylindrical joints 310 can be rotated in a single direction, i.e. the radial direction of the cylindrical joint head and the cylindrical joint socket. Thus the rigidity of the support structure 300 can be increased by the cylindrical joints 310 and the sway of the support structure 300 can be avoided. The ball joints 320 with higher degree of freedom are arranged close to the image capturing device 420 to easily adjust the position of the image capturing device 420 when the document projector 400 is operated.

Accordingly, the present invention provided the following advantages. The support structure use the cylindrical joints, wherein the contact area between the cylindrical joints is larger than the contact area between the ball joints, therefore the friction force between the cylindrical joint head and the cylindrical joint socket is increased. The cylindrical joints may increase the rigidity of the support structure and prevent sway of the support structure. The support structure may include the ball joints and the cylindrical joints, wherein the cylindrical joints can provide the support structure better rigidity, and the ball joints can provide the support structure better degree of freedom during positioning.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A support structure comprising a plurality of cylindrical joints, each cylindrical joint comprising:
a cylindrical joint body having a wire channel for being passed through by a wire;
a cylindrical joint head disposed on one end of the cylindrical joint body and having the wire channel;
a cylindrical joint socket disposed on another end of the cylindrical joint body and having the wire channel, wherein the cylindrical joint socket is coupled to another cylindrical joint head;
a plurality of grooves disposed on the cylindrical joint head, wherein the grooves are arranged on opposite sides of the wire channel along a radial direction of the cylindrical joint head; and
a plurality of pins disposed on the cylindrical joint socket and arranged at opposites sides of the wire channel and touching the grooves,
thereby the cylindrical joints are connected one by one and are rotated along the grooves and stopped by the pins.

2. The support structure of claim 1, wherein the material of the cylindrical joints is plastic.

3. A support structure comprising:
at least one cylindrical joint, each of the least one cylindrical joint comprising:
a cylindrical joint body having a wire channel for being passed through by a wire;
a first cylindrical joint head disposed on one end of the cylindrical joint body and having the wire channel;
a first cylindrical joint socket disposed on another end of the cylindrical joint body and having the wire channel;
a plurality of first grooves disposed on the first cylindrical joint head, wherein the first grooves are arranged on opposite sides of the wire channel along a radial direction of the cylindrical joint head; and
a plurality of first pins disposed on the first cylindrical joint socket and arranged at opposites sides of the wire channel and touching the grooves;
at least one ball joint, each of the least one ball joint comprising:
a ball joint body having the wire channel;
a second ball joint head disposed on an end of the ball joint body and having the wire channel;
a second ball joint socket disposed on another end of the ball joint body and having the wire channel;
a second cavity disposed on an inner surface of the second ball joint socket; and
a second protrusion disposed on an outer surface of the second ball joint head; and
an adapter joint for connecting the least one cylindrical joint and the least one ball joint, the adapter joint comprising:
an adapter joint body having the wire channel;
a third cylindrical joint socket disposed on an end of the adapter joint body and having the wire channel, wherein the third cylindrical joint socket is coupled to the first cylindrical joint head of the least one cylindrical joint;
a third ball joint head disposed on another end of the adapter joint body and having the wire channel, wherein the third ball joint head is coupled to the second ball joint socket of the least one ball joint;
a plurality of third pins disposed on the third cylindrical joint socket and touching the first grooves for positioning; and
a third protrusion disposed on an outer surface of the third ball joint head and coupling to the second cavity for positioning.

4. The supporting structure of claim 3, wherein the material of the least one cylindrical joint, the least one ball joint, and the adapter joint is plastic.

5. The supporting structure of claim 3, wherein the protrusion has an arch edge.

6. The supporting structure of claim 3, wherein the number of the least one cylindrical joint and the least one ball joint is plural, and the cylindrical joints are coupled one by one with coupling the first cylindrical joint heads to the first cylindrical joint sockets, and the ball joints are coupled one by one by coupling the second ball joint heads to the second ball joint sockets.

7. The support structure of claim 6, further comprising a base and a lower joint, wherein the lower joint connects the cylindrical joints and the base.

8. The support structure of claim 6, further comprising an electronic device and an upper joint, wherein the upper joint connects the ball joints and the electronic device.

9. A document projector using the support structure of claim 1, the document projector comprising:
a base;
an image capturing device; and
the support structure, wherein the support structure further comprises a lower joint for connecting one of the cylindrical joints and the base, and an upper joint for connecting one of the cylindrical joints and the image capturing device.

10. A document projector using the support structure of claim 3, the document projector comprising:
a base;
an image capturing device; and
the support structure, wherein the support structure further comprises a lower joint for connecting the least one cylindrical joint and the base, and an upper joint for connecting the least one ball joint and the image capturing device.
